(19) United States
(12) Patent Application Publication
(10) Pub. No.: US 2008/0006300 A1
(43) Pub. Date: Jan. 10, 2008

(54) Laundry machine and method of controlling steam generator thereof

(75) Inventors: In Geun Ahn, Changwon-si (KR); Kyu Won Lee, Yeonje-gu (KR); Seong Moon II, Seoul (KR)

Correspondence Address: MCKENNA LONG & ALDRIDGE LLP, 1900 K STREET, NW, WASHINGTON, DC, 20006, US

(73) Assignee: LG. Electronics, Inc., Seoul (KR)

(21) Appl. No.: 11/819,920

(22) Filed: Jun. 29, 2007

(30) Foreign Application Priority Data
Jun. 30, 2006 (KR) 10-2006-0061540

(51) Int. Cl. D06F 37/42; B08B 3/00

(52) U.S. Cl. 134/18; 68/5 R

(57) ABSTRACT

A laundry machine and controlling method thereof are disclosed, by which malfunctions of a steam generator and laundry machine and fire due to the overheating of a heater can be prevented. The present invention includes a steam generator having a heater and a controller turning of the heater if an operation time of the heater exceeds a operation limit time set in the course of driving the heater.

This application claims the benefit of the Korean Patent Application No. 10-2006-0061540, filed on Jun. 30, 2006, which is hereby incorporated by reference as if fully set forth herein.

### BACKGROUND OF THE INVENTION

1. Field of the Invention

The present invention relates to a laundry machine, and more particularly, to a laundry machine and controlling method thereof. Although the present invention is suitable for a wide scope of applications, it is particularly suitable for performing washing using a steam generator.

2. Discussion of the Related Art

Recently, a steam generator is a generalized device for raising a washing power of a washer or preventing/removing wrinkles of laundry in a dryer.

A washer having a steam generator is explained as follows.

FIG. 1 is a perspective diagram of a drum type washer having a steam generator and FIG. 2 and FIG. 3 are perspective diagrams of a steam generator according to a related art.

Referring to FIG. 1, a drum type washer consists of a cabinet 10 configuring an exterior of the drum type washer, a cylindrical tub 20 horizontally supported within the cabinet 10 to store water therein, a drum 30 rotatably provided within the tub 20 to have perforated holes for enabling water and steam to be introduced into the drum 30, a driving motor (not shown in the drawing) for driving the drum 30, and at least one steam generator 50 for supplying steam into the drum 30.

Besides, a water supply valve 15 is further provided to one side of the drum type washer to supply water to the tub 20 by being connected to a water pipe (not shown in the drawing) or the like.

In particular, the steam generator 50 is connected to the water supply valve 15 to introduce the water therein. The steam generator 50 generates steam by heating the water stored therein and then supplies the generated steam to the drum 30.

A steam supply pipe 53 is provided to one side of the steam generator 50 to play a role as a path for guiding to inject the steam generated by the steam generator 50 into the drum 30.

Preferably, a passage of the steam generator 50 ranging from the water supply valve 15 to the steam supply pipe 53 is configured relatively short. Preferably, the steam generator 50 is provided over the tub 20 to facilitate repair and maintenance check.

The steam generator 50 is explained in detail with reference to FIG. 2 and FIG. 3 as follows.

Referring to FIG. 2, the steam generator 50 consists of a base case 51 configuring an exterior of the steam generator 50 to store water therein, a cover case 52 assembled to a topside of the base case 51, and a heater 55 for heating the water stored in the steam generator 50.

A water inlet 52a connected to the water supply valve 15 is provided to one side of the cover case 52 to enable water to be introduced into the steam generator 50. And, an outlet 52b connected to a steam supply pipe 53 for supplying generated steam to the drum 20 is provided to the other side of cover case 52.

Referring to FIG. 3, the heater 55 is provided to a lower part of the base case 51. And, the heater 55 operates to directly heat the water by sinking under the water introduced into the steam generator 50.

A water level sensor for detecting a level of water stored within the steam generator 50 and a temperature sensor 57 for measuring a temperature within the steam generator 50 are provided to one side of the cover case 52.

If the temperature measured by the temperature sensor 57 exceeds a reference value, a controller cuts off a power of the heater 55 to prevent the heater 55 from overheating.

The water level sensor 56 consists of a common electrode 56a, a low water level electrode 56b, a high water level electrode 56, and the like. Preferably, a length of the common electrode 56a is set equal to or greater than a terminal length of the low water level electrode 56b. If the common electrode 56a and the low water level electrode 56b submerge under the water, a controller (not shown in the drawing) of a washer decides that the water level corresponds to a low water level. If the high water level electrode 56c submerges under the water 56c, the controller decides that water level corresponds to a high water level.

Once the water level of the water within the steam generator 50 reaches the low water level, the water supply valve 15 is turned on to supplement water. If the water level of the stored water is higher than the high water level, the water supply valve 15 is turned off to stop supplying the water. The heater 55 is then driven to generate steam.

A method of controlling the above-configured steam generator in the washer according to a related art is explained with reference to FIG. 4 as follows.

FIG. 4 is a flowchart of a method of controlling a steam generator in a washer according to a related art.

Referring to FIG. 4, if the steam generator 50 is driven, water supply is carried out in a manner that water is supplied to the steam generator 50 up to a reference water level, i.e., a high water level (S1).

After completion of the water supply (S1), the steam generator 50 starts to generate steam by turning on the heater 55 provided within the steam generator 50 (S2).

The controller (not shown in the drawing) of the washer decides whether an internal water level detected by the water level sensor 56 reaches a low water level (S3).

If the internal water level reaches the low water level (S3), the heater 55 is turned off (S4) and the water supply is resumed (S1).

If the internal water level does not reach the low water level (S3), the heater 55 keeps being driven.

If an internal temperature of the steam generator reaches a preset temperature, the heater 55 is turned off to end the operation of the steam generator 50.

However, the related art washer has the following problems.

First of all, if the low water level electrode for detecting the low water level is malfunctioning or if the water level detection is erroneous due to other reasons despite the normally functioning low water level electrode, the steam generator may overheat to set fire.

Although an actual water level goes below the low water level to expose the heater, the water level detected by the water level electrode is decided as exceeding the low water level. So, the heater keeps being driven to cause a problem. This problem may be caused by the malfunctioning low water level electrode or the decision error of the controller.

Moreover, the problem is caused by other reasons as well as the malfunctions of the associated devices. Even if the entire devices associated with the low water level detection normally operate as well as the low water level electrode, the above problem may take place.

In particular, the water boiled by the driven heater forms bubbles. So, the bubbles may interrupt the correct detection of the actual water level. Even if an actual water level is below the low water level, the bubbles generated from the boiling water comes into contact with the high level electrode to make the controller decide that the low water level is not reached yet. So, the heater keeps being driven to cause the overheating and fire problems.

Besides, if the heater is driven unnecessarily for a long time, power consumption increases.

### SUMMARY OF THE INVENTION

Accordingly, the present invention is directed to a laundry machine and controlling method thereof that substantially obviate one or more problems due to limitations and disadvantages of the related art.

An object of the present invention is to provide a laundry machine and controlling method thereof, by which malfunctions of a steam generator and washer and fire due to the overheating of a heater can be prevented.

Another object of the present invention is to provide a laundry machine and controlling method thereof, by which a more accurate operation limit time can be provided in a manner of setting an operation limit time of a heater by considering various factors including a heater applied voltage, a water quantity, a temperature varying rate, and the like.

Another object of the present invention is to provide a laundry machine and controlling method thereof, by which unnecessary power consumption can be reduced in a manner of preventing a heater from overheating by an incorrect detection of a water level.

Another object of the present invention is to provide a laundry machine and controlling method thereof, by which reliability can be enhanced in a manner of controlling a heater to be turned on or off according to a water level detection and an operation time limit time.

A further object of the present invention is to provide a laundry machine and controlling method thereof, by which inconvenience caused by the failure or repair of a steam generator can be prevented in a manner of preventing malfunction of the steam generator.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a laundry machine according to the present invention includes a steam generator having a heater and a controller turning of the heater if an operation time of the heater exceeds a operation limit time set in the course of driving the heater.

Preferably, the operation limit time can be set in advance before the steam generator is driven. Alternatively, the operation limit time can be set in the course of driving the heater to count a time taken for water over a predetermined water level to turn into steam to be discharged more precisely. As the heater is turned off after expiration of the operation limit time, a problem caused by the overheating of heater is prevented.

Preferably, the operation limit time is updated by being decided at least twice. Namely, the operation limit time can be updated by considering a temperature variation of the water in the course of driving the heater.

Preferably, the operation limit time is decided based on a level of a voltage applied to the heater. It is able to calculate a quantity of exothermic heat per time from the heater using the voltage applied to the heater. Once the quantity of the exothermic heat per the time is obtained, it is able to obtain the time necessary for supplying the quantity of heat to turn a predetermined quantity of water into steam entirely. So, this time can be decided as the operation limit time.

Preferably, the operation limit time is decided based on a quantity of water accommodated in the steam generator. If a quantity of exothermic heat of the heater is decided, it is able to set the operation limit time to the time necessary to turn a predetermined quantity of water into steam by considering the quantity of the water within the steam generator.

More preferably, the water quantity is decided based on a turned-on time of a water supply valve.

More preferably, the water quantity is decided based on a water level within the steam generator. For instance, by considering the water quantity ranging from a low water level to a high water level, it is able to set the operation limit time to a time taken to turn the water quantity into steam entirely.

More preferably, the water quantity is decided based on a water pressure within the steam generator. In this case, a water pressure sensor for measuring the water pressure within the steam generator is necessary. If the water pressure is obtained, the water level is obtained. So, the water quantity can be obtained.

More preferably, the water quantity is decided based on a variation rate of an internal temperature of the steam generator or a water temperature. Assuming that a quantity of exothermic heat of the heater is constant, the variation rate has correlation with the water quantity. So, it is able to decide the water quantity using the correlation.

In this case, the variation rate of the internal temperature of the steam generator or the water is measured within a range between 50˜100° C. Since an instantaneous variation rate of temperature may be considerably erroneous, it is more preferable that an average variation rate during a predetermined temperature interval is used.

In another aspect of the present invention, a laundry machine includes a steam generator having a heater and a temperature sensor and a water quantity detecting unit detecting a water quantity using a variation rate of a temperature sensed by the temperature sensor within the steam generator.

Preferably, the temperature within the steam generator is a temperature of water within the steam generator.

Preferably, the laundry machine further includes a controller controlling a water supply to the steam generator according to a detecting result of the water quantity detecting unit.

Preferably, the laundry machine further includes a controller controlling the heater according to a detecting result of the water quantity detecting unit.

More preferably, the laundry machine further includes a controller controlling a water supply to the steam generator or the heater according to a detecting result of the water quantity detecting unit.

In another aspect of the present invention, a laundry machine includes a steam generator having a heater, a water pressure sensor measuring a water pressure of water within the steam generator, and a water quantity detecting unit detecting a water quantity within the steam generator using the sensed water pressure.

In another aspect of the present invention, a method of controlling a steam generator in a laundry machine includes a water supplying step of performing a water supply, a heating step of driving a heater, a time setting step of setting an operation limit time for driving the heater in the course of driving the heater, and a heater turning-off step of turning off the heater if the operation limit time expires.

Preferably, the method further includes the step of turning off the heater if a water level within the steam generator is lower than a reference water level while the operation limit time does not expire.

Preferably, the operation limit time is decided based on a level of a voltage applied to the heater.

Preferably, the method further includes the step of detecting a water level within the steam generator.

More preferably, the operation limit time is decided based on the detected water quantity.

More preferably, the detected water quantity is decided based on a variation rate of an internal temperature of the steam generator or a water temperature.

More preferably, the water quantity is detected before the time setting step.

More preferably, the method further includes the step of supplying water to the steam generator in addition if the detected water quantity is smaller than a reference water quantity.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective diagram of a drum type washer having a steam generator;

FIG. 2 and FIG. 3 are perspective diagrams of a steam generator according to a related art;

FIG. 4 is a flowchart of a method of controlling a steam generator in a washer according to a related art;

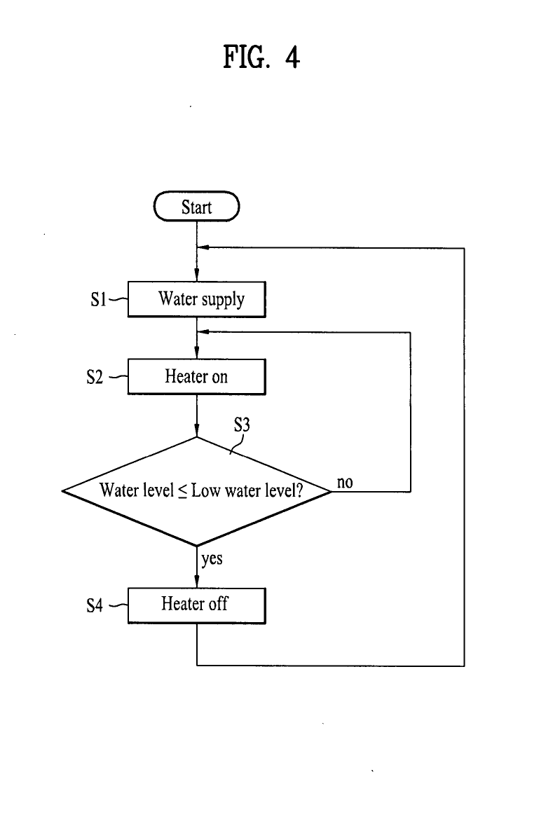

FIG. 5 is a flowchart of a method of controlling a steam generator in a washer according to a first embodiment of the present invention;

FIG. 6 is a flowchart of a method of controlling a steam generator in a washer according to a second embodiment of the present invention;

FIG. 7 is a graph of a method of measuring a temperature varying rate of a steam generator of the present invention; and

FIG. 8 is a flowchart of a method of controlling a steam generator in a washer according to a third embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

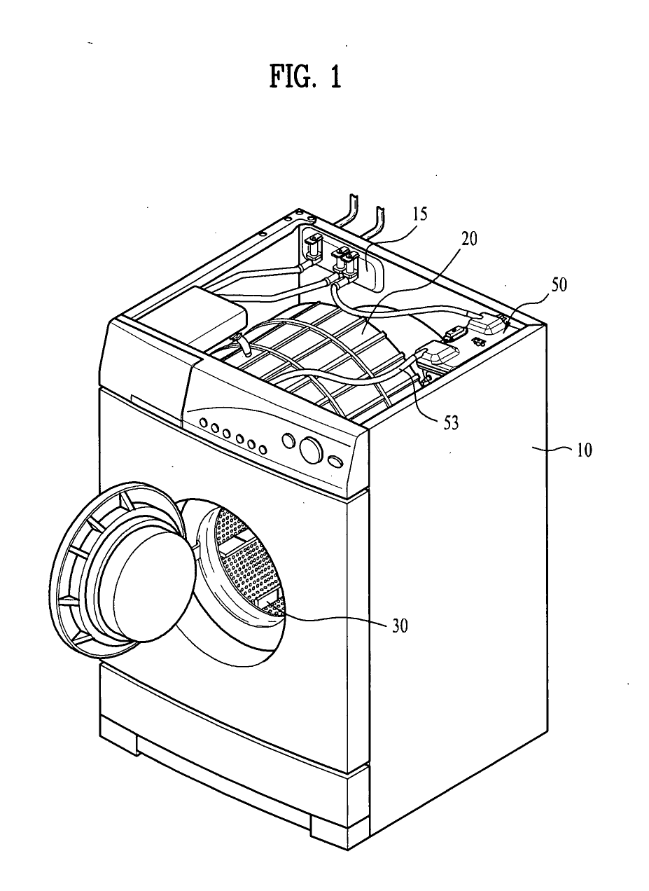

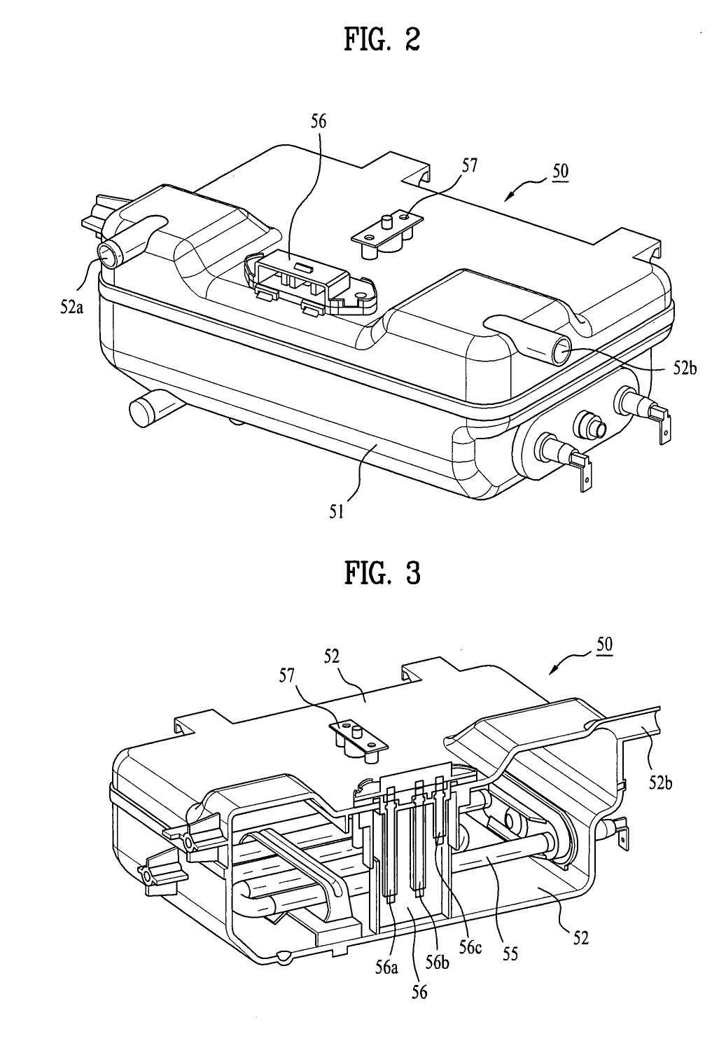

First of all, since a washer according to the present invention includes a controller for turning off a heater of a steam generator after expiration of a predetermined setup time, the exterior and elements of the washer of the present invention may be similar to those of the related art shown in FIGS. 1 to 3.

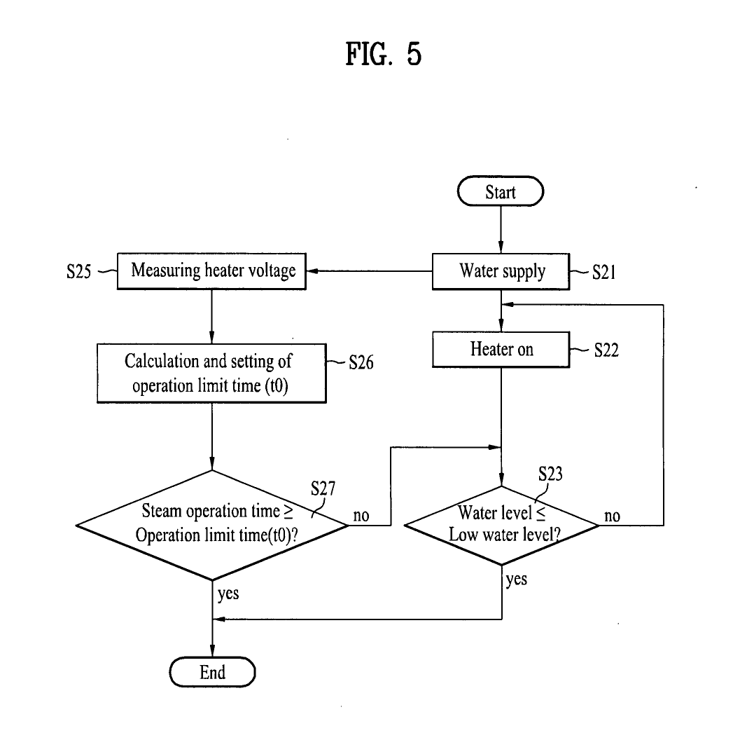

FIGS. 5 to 8 are flowcharts for operational methods of a washer according to the present invention. And, a controller included in a washer of the present invention can control the washer by the steps shown in FIGS. 5 to 8. And, an operational program corresponding to the operational method can be loaded in the controller.

So, for the embodiments of a washer according to the present invention, the operational methods shown in FIGS. 5 to 8 are explained with reference to the related art washer shown FIGS. 1 to 3.

To execute a steam operation in a washer according to the present invention, a quantity of water within the steam generator 50 is detected using the water level sensor 56. If the detected water quantity is below a reference water quantity, the water supply valve 15 is turned on to perform water supply in a manner that the water quantity reaches the reference water quantity. In this case, the reference water quantity may correspond to the high water level measured by the high water level terminal 56c like the related art for example.

If an internal temperature of the washer reaches a preset temperature, the operation of the heater 55 is terminated.

Preferably, a position, e.g., a height or the like, of the temperature sensor provided to the steam generator 50 of the washer is variable to measure a water temperature or an internal temperature within the steam generator 50.

A washer according to a first embodiment of the present invention is explained as follows.

First of all, a voltage applied to the heater 55 is measured. Preferably, the measured voltage is used in setting an operation limit time t0 of the heater 55.

If a water temperature, which is measured by the temperature sensor 57, within the steam generator 50 and a water quantity accommodated within the stem generator 50 are obtained, it is able to calculate the quantity of exothermic heat required for evaporating the water supplied up to the reference water level by the formula, Q=CVT.

In this case, Q is a quantity of exothermic heat, C is a specific heat of water, V is a volume of water, and T is a temperature of water. Since the water supply is normally carried out up to the reference water level, the water quantity can be obtained from measuring the water quantity previously reaching the reference water level.

In this case, energy supplied by the heater 55 in the steam generator 50 is electric energy and can be expressed as Q=P*T, where P and T are power and time, respectively. So, the heat quantity Q can be expressed in terms of voltage (V) and resistance (R). In this case, the resistance (R) is a resistance of the heater and may have a fixed value. And, the temperature (T) is measurable. Hence, a time taken to evaporate the water quantity can be calculated by measuring the voltage (V) according to the formula Q=V*V/R*T. Likewise, the operation limit time (t0) set in this case is preferably set to a value within a range for preventing the washer from malfunctioning or setting a fire due to the transformation of the structure of the steam generator 50 having the overheated heater.

If the operation limit time (t0) is set in the course of driving the heater, the washer unconditionally stops operating if the operation limit time (t0) expires from the timing point of setting the operation limit time (t0). So, the operation limit time (t0) has a meaning of a remaining operation limit time (t).

The embodiment of the present invention is explained in detail with reference to FIG. 5 as follows.

First of all, if a washer starts a steam operation, water supply is carried out until a reference water level is reached (S21). The heater 55 is then turned on (S22).

In doing so, the controller of the washer measures a voltage applied to the heater 55 (S25) and calculates and sets the operation limit time (t0) of the heater 55 according to the aforesaid calculating method (S26).

While steam is generated by the heater 55, the controller counts an operation time of the heater. If the counted operation time of the heater 55 passes the operation limit time t0 (S27), the steam operation is terminated.

Meanwhile, if it is detected that the water level within the steam generator 50 corresponds to the low water level via the water level sensor 56 (S23), the controller ends the steam operation even if the set time does not expire.

A washer according to a second embodiment of the present invention is explained as follows.

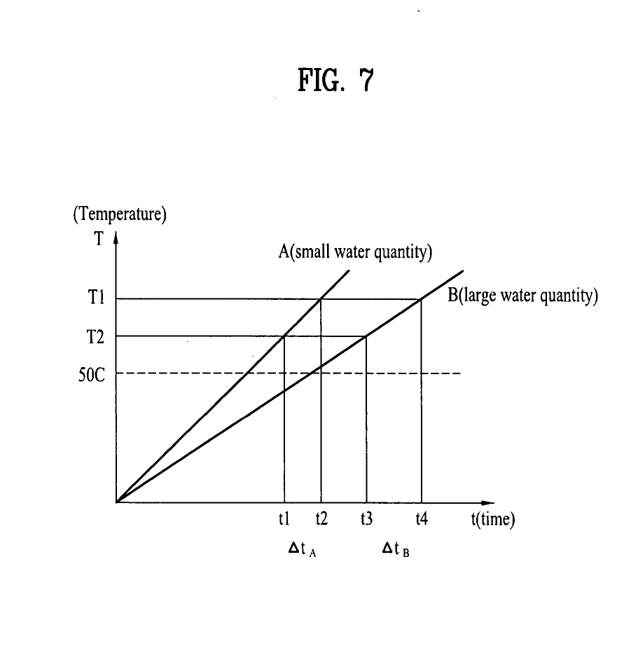

First of all, the washer can consider an internal temperature of the steam generator 50 or a varying rate of a water temperature as well as a voltage applied to the heater 55 in calculating an operation limit time (t0). Referring to FIG. 7, comparing a graph line (A) for a small water quantity to a graph line (B) for a large water quantity, there is no difference in a temperature variation quantity resulting from subtracting a second setup temperature T2 from a first setup temperature T1. Yet, a taken time of the graph (A), which is a unit time A tA, differs from a taken time of the graph (B) which is a unit time ΔtB. In this case, the unit time ΔtA is (t2−t1) and the unit time ΔtB is (t4−t3).

In the graph, the case of the small water quantity has a greater variation rate of temperature per unit time. So, it is decided that there is a small water quantity if a variation of a temperature per unit time is considerable according to the internal temperature or the variation rate of the water temperature. And, it is decided that there is a large water quantity if a variation of a temperature per unit time is small. By writing a table resulting from calculating a variation rate of temperature or water temperature, a corresponding water quantity can be obtained.

And, by ignoring error caused by water temperature, it is able to set a time for driving the heater 55 with the obtained water quantity only. Yet, it is more preferable that a quantity of exothermic heat is calculated by considering a measured water quantity and that an operation limit time (t0) of the heater 55 is set.

Preferably, the variation rate of the internal temperature of the steam generator 50 or the water temperature is measured as an average value during a predetermined duration within a temperature range of 50˜100° C.

Alternatively, an operation limit time (t0) can be calculated by finding a supplied water quantity by measuring a turning-on/off time of the water supply valve 15. As soon as water supply proceeds by turning on the water supply valve 15, the controller counts the time taken for the water supply to calculate a water quantity based on the counted time.

If a quantity of water passing through a water supply pipe (not shown in the drawing) for supplying water to the washer from the water supply valve 15 is obtained, it is able to calculate a quantity of the supplied water in a manner of measuring a time of turning on the water supply pipe and then multiplying the measured time by the quantity of the water passing through the water supply pipe per unit time.

In performing water supply in the early stage, the water supply is normally carried out until a reference water level is reached. So, it facilitates a water quantity to be obtained. In performing additional water supply, it is able to obtain a water quantity by adding the calculated supplied water quantity to the water quantity within the steam generator 50 detected by the water level sensor 300.

Alternatively, it is able to obtain a water quantity by providing a pressure sensor (not shown in the drawing) for measuring a water pressure to a bottom of the steam generator 50. In particular, it is able to obtain a water quantity using a size of the bottom ad a pressure value detected by the pressure sensor.

A method of controlling the steam generator in the washer according to the present invention is explained as follows.

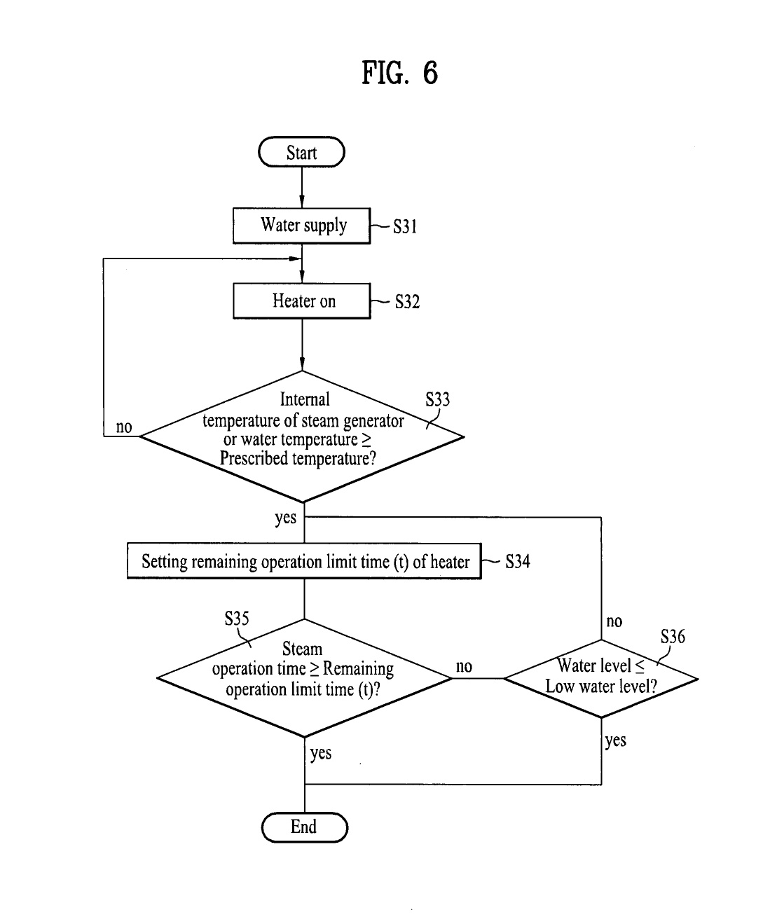

FIG. 6 is a flowchart of a method of controlling a steam generator in a washer according to a second embodiment of the present invention.

Referring to FIG. 6, after completion of water supply (S31), the heater 5 is turned on to heat water (S32).

If it is detected that an internal temperature of the steam generator or a water temperature reaches a prescribed temperature (S33), a remaining operation limit time (t) for driving a steam operation is set (S34).

In this case, the controller of the washer measures a voltage applied to the heater 55. The voltage can be obtained from a power supply unit for supplying the voltage to the heater. Alternatively, the voltage may be decided in advance when the washer is designed.

Alternatively, a current supplied to the heater 55 can be used. This is because a power applied to the heater can be calculated using a current and a resistance.

The controller measures a variation rate of the internal temperature or the water temperature within the steam generator via the temperature sensor 57 to obtain a water quantity. Alternatively, a turning-on/off time of the water supply valve 15 can be measured. Alternatively, a water quantity can be obtained by providing a pressure sensor (not shown in the drawing) to a bottom of the steam generator 50. Preferably, the remaining operation limit time (t) is calculated and set using the above-explained measuring methods entirely. Optionally, the remaining operation limit time (t) can be calculated using the applied voltage of the heater 55 only.

The controller sets and stored the remaining operation limit time (t) to operate the heater 55 using the applied voltage of the heater 55, the measured temperature varying rate, the turning-on/off time of the water supply valve 15 or the pressure.

While the heater 55 is driven, the controller counts a time taken to drive the heater 55. If the counted operation time exceeds the remaining operation limit time (t) (S35), the controller ends the steam operation.

Meanwhile, the water level sensor 56 detects the low water level (S36), the controller ends the steam operation.

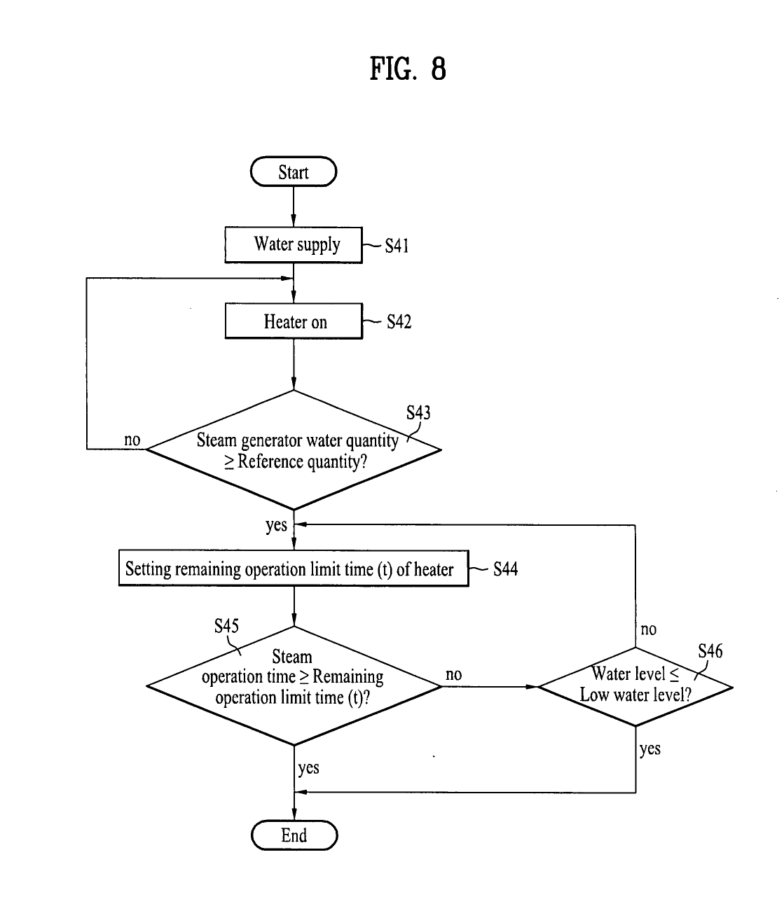

A method according to a third embodiment of the present invention is explained with reference to FIG. 8 as follows.

First of all, the method according to the third embodiment of the present invention is similar to the former method according to the second embodiment of the present invention. Yet, the method according to the third embodiment of the present invention differs from the former method according to the second embodiment of the present invention in that a water quantity within the steam generator 50 is detected to decide whether to set a remaining operation limit time (t) instead of detecting the internal temperature or the water temperature of the steam generator 50 in the step S33.

If it is detected that the water quantity of the steam generator 50 exceeds a reference water quantity (S43), a remaining operation limit time (t) is set. If it is detected that the water quantity of the steam generator 50 is smaller that a reference water quantity (S43), additional water supply is carried out (S41).

If the remaining operation limit time (t) expires (S45), a steam operation is forced to end. If a low water level is detected (S46), the stem operation is ended like the step of the former embodiment of the present invention.

Hence, even if the water level sensor 56 malfunctions in detection, the washer according to the present invention turns off the heater 55 after elapse of a setup time. So, the heater 55 avoids overheating to prevent the malfunction or fire of the steam generator 50 or the washer.

In the embodiment of the present invention, the water level sensor 56 is included. Yet, since the water quantity within the steam generator is obtained by the above-mentioned methods, the water level sensor 56 is not mandatory for the present invention.

Accordingly, the present invention provides the following effects of advantages.

First of all, malfunctions of a steam generator and laundry machine and fire due to the overheating of a heater can be prevented.

Secondly, a more accurate operation limit time can be provided in a manner of setting an operation limit time of a heater by considering various factors including a heater applied voltage, a water quantity, a temperature varying rate, and the like.

Thirdly, unnecessary power consumption can be reduced in a manner of preventing a heater from overheating by an incorrect detection of a water level.

Fourthly, reliability can be enhanced in a manner of controlling a heater to be turned on or off according to a water level detection and an operation time limit time.

Fifthly, inconvenience caused by the failure or repair of a steam generator can be prevented in a manner of preventing malfunction of the steam generator.

It will be apparent to those skilled in the art that various modifications and variations can be made in the present invention without departing from the spirit or scope of the inventions. For instance, the steam generator according to the present invention is applicable to a dryer using steam. Thus, it is intended that the present invention covers the modifications and variations of this invention provided they come within the scope of the appended claims and their equivalents.

What is claimed is:

1. A laundry machine comprising:
a steam generator having a heater; and
a controller turning off the heater if an operation time of the heater exceeds a operation limit time set in the course of driving the heater.

2. The laundry machine of claim 1, wherein the operation limit time is updated by being decided at least twice.

3. The laundry machine of claim 1, wherein the operation limit time is decided based on a level of a voltage applied to the heater.

4. The laundry machine of claim 1, wherein the operation limit time is decided based on a quantity of water accommodated in the steam generator.

5. The laundry machine of claim 4, wherein the water quantity is decided based on a turned-on time of a water supply valve.

6. The laundry machine of claim 4, wherein the water quantity is decided based on a water level within the steam generator.

7. The laundry machine of claim 4, wherein the water quantity is decided based on a water pressure within the steam generator.

8. The laundry machine of claim 4, wherein the water quantity is decided based on a variation rate of an internal temperature of the steam generator or a water temperature.

9. The laundry machine of claim 8, wherein the variation rate of the internal temperature of the steam generator or the water temperature is measured within a range between 50˜100° C.

10. A laundry machine comprising:
a steam generator having a heater and a temperature sensor; and
a water quantity detecting unit detecting a water quantity using a variation rate of a temperature sensed by the temperature sensor within the steam generator.

11. The laundry machine of claim 10, wherein the temperature within the steam generator is a temperature of water within the steam generator.

12. The laundry machine of claim 10, further comprising a controller controlling a water supply to the steam generator according to a detecting result of the water quantity detecting unit.

13. The laundry machine of claim 10, further comprising a controller controlling the heater according to a detecting result of the water quantity detecting unit.

14. The laundry machine of claim 13, further comprising a controller controlling a water supply to the steam generator or the heater according to a detecting result of the water quantity detecting unit.

15. A laundry machine comprising:
a steam generator having a heater;
a water pressure sensor measuring a water pressure of water within the steam generator; and
a water quantity detecting unit detecting a water quantity within the steam generator using the sensed water pressure.

16. A method of controlling a steam generator in a laundry machine, comprising:
a water supplying step of performing a water supply;
a heating step of driving a heater;
a time setting step of setting an operation limit time for driving the heater in the course of driving the heater; and
a heater turning-off step of turning off the heater if the operation limit time expires.

17. The method of claim 16, further comprising the step of turning off the heater if a water level within the steam generator is lower than a reference water level while the operation limit time does not expire.

18. The method of claim 16, wherein the operation limit time is decided based on a level of a voltage applied to the heater.

19. The method of claim 16, further comprising the step of detecting a water quantity within the steam generator.

20. The method of claim 19, wherein the operation limit time is decided based on the detected water quantity.

21. The method of claim 19, wherein the detected water quantity is decided based on a variation rate of an internal temperature of the steam generator or a water temperature.

22. The method of claim 19, wherein the water quantity is detected before the time setting step.

23. The method of claim 19, further comprising the step of supplying water to the steam generator in addition if the detected water quantity is smaller than a reference water quantity.
